(19) United States
(12) Patent Application Publication
(10) Pub. No.: US 2009/0136159 A1
(43) Pub. Date: May 28, 2009

(54) METHOD AND SYSTEM FOR EDITING A DATE OF A DIGITAL IMAGE IN AN IMAGING DEVICE

(75) Inventor: QI-DA GUAN, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/185,131

(22) Filed: Aug. 4, 2008

(30) Foreign Application Priority Data
Nov. 26, 2007 (CN) 200710202659.5

(51) Int. Cl. G06K 9/03; H04N 5/76

(52) U.S. Cl. 382/311; 348/231.5

(57) ABSTRACT

A method for editing a date of a digital image file having a predefined date stamp location in an imaging device, wherein the image data of the digital image, and a position coordinate of the predefined date stamp location, are stored in the digital image file. The method includes: selecting the digital image having the predefined date stamp location; obtaining and saving the image data and the position coordinate of the predefined date stamp location from the digital image file; generating a new date according to a user input; modifying the image data of the predefined date stamp location with the new date to form a first date stamp; and applying the first date stamp according to the position coordinate of the predefined date stamp location.

### BACKGROUND

1. Field of the Invention

Embodiments of the present disclosure relate to imaging devices, and more particularly to a method and system for editing a date of a digital image in an imaging device.

2. Description of Related Art

Generally, imaging devices such as digital video and still cameras, include a real-time clock, which provides a current date/time. Images captured by an imaging device may comprise a current date/time stored as metadata within a digital image file of the captured image. Imaging devices typically stamp digital images with a current date/time because the date/time metadata is very valuable in organizing images for easy retrieval.

However, a date stamp is only useful if the real-time clock has been properly set before capturing an image. In many imaging devices, a date must be set before the imaging device is ever used, and then again whenever new batteries are installed in the imaging device. Unfortunately, users often do not want to bother having to set the clock each time they replace the batteries. If users do not properly set the clock, or forget to stamp captured images captured with the date/time, a default date and time (such as Jan. 1, 2000 12:00:00 am) is recorded with the captured images, or a date and time is not recorded with the captured images. Therefore the date/time metadata may provide an incorrect date/time, or may not provide any date/time, making image retrieval difficult.

Therefore, it is desirable to provide a method and a system for editing a date and time metadata in an imaging device, which can overcome the above mentioned problems.

### SUMMARY

A method for editing a date of a digital image file having a predefined date stamp location in an imaging device, wherein the image data of the digital image, and a position coordinate of the predefined date stamp location, are stored in the digital image file. The method includes: selecting the digital image having the predefined date stamp location; obtaining and saving the image data and the position coordinate of the predefined date stamp location from the digital image file; generating a new date according to a user input; modifying the image data of the predefined date stamp location with the new date to form a first date stamp; and applying the first date stamp according to the position coordinate of the predefined date stamp location.

Other advantages and novel features of the present invention disclosure will become more apparent from the following detailed description of certain inventive embodiments of the present disclosure when taken in conjunction with the accompanying drawings, in which:

### BRIEF DESCRIPTION OF THE DRAWINGS

FIG. 1 is a block diagram of one embodiment of a system for editing a date of a digital image in an imaging device; and

FIG. 2 is a flowchart of one embodiment of a method for editing a date of a digital image in an imaging device.

### DETAILED DESCRIPTION

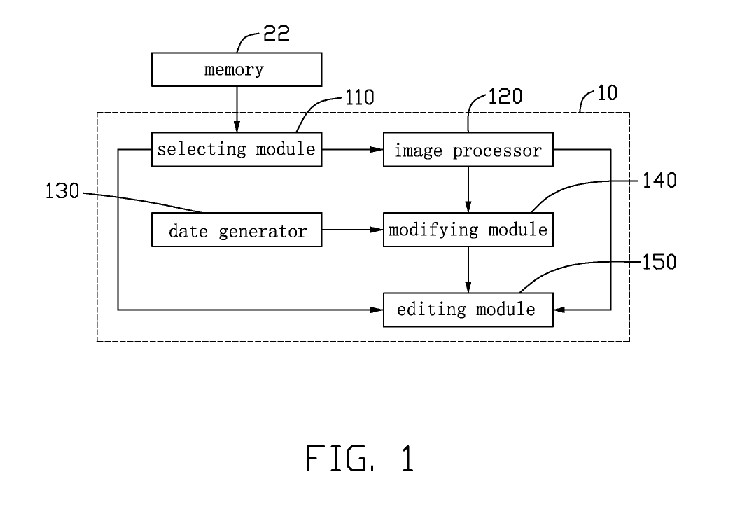

FIG. 1 is a block diagram of one embodiment of a system 10 configured to edit a date of a digital image having a predefined date stamp location in an imaging device. The imaging device includes a memory 22 for pre-storing a position coordinate of the predefined date stamp location. When the digital image is captured by the imaging device, the predefined date stamp location is determined according to a position coordinate of the predefined date stamp location. Specifically, the position coordinate of the predefined date stamp location can be reset according to a user's input when a stamping date model is operated in the imaging device. In one embodiment, each digital image captured by the imaging device may be recorded as a digital image file in the Exif file format, Tag Image File Format (TTFF) or JPEG. (Joint Photographic Experts Group) 2000 file format. The image data of the predefined date stamp location and the position coordinate of the predefined date stamp location are written in a header of the digital image file.

The system 10 includes a selecting module 110, an image processor 120, a date generator 130, a modifying module 140 and an editing module 150. The selecting module 110 is configured for selecting a digital image having a predefined date stamp location from the imaging device, such as a digital video or still camera, for example. The image processor 120 is configured for obtaining and saving image data, from the digital image, and a position coordinate of the predefined date stamp location from a header of the digital image file. The date generator 130 is configured for generating a new date according to a user input. The modifying module 140 is configured for modifying the image data of the predefined date stamp location with the new date to form a first date stamp or a new date stamp. The editing module 150 is configured for applying the first date stamp or replacing the old date stamp with the new date stamp according to the position coordinate of the predefined date stamp location saved in the image processor 120.

Advantageously, the image processor 120 may comprise a digital signal processor (DSP) for processing various functions of the imaging device. The date generator 130 can act as a system clock of the imaging device for generating a current date for the imaging device. The memory 22 can digitally store a number of digital images onto the memory 22. The selecting module 110 selects digital images from the memory 22 of the imaging device.

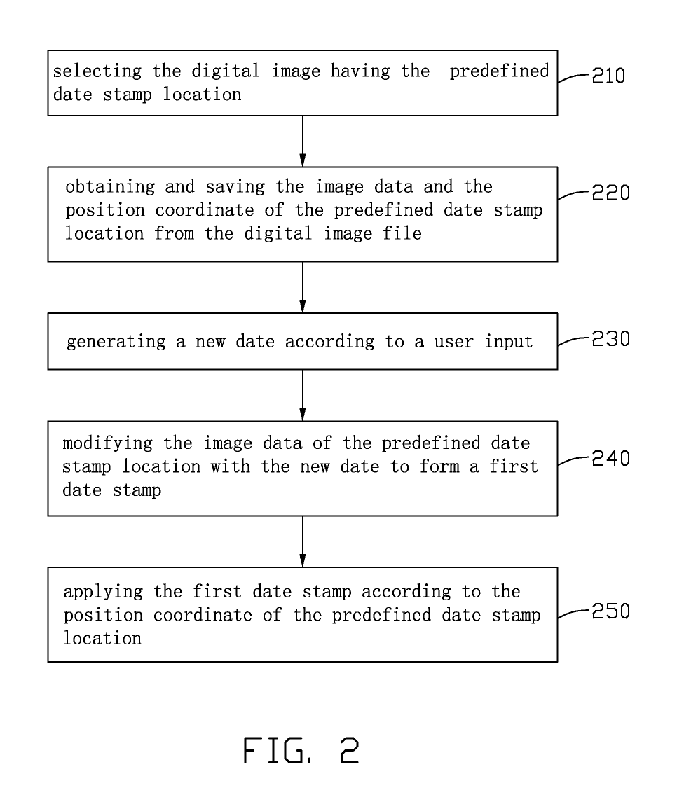

FIG. 2 is a flowchart of one embodiment of a method for editing a date of a digital image in an imaging device. Depending on the embodiment, the flowchart of FIG. 2 may comprise fewer or more steps, and the steps may be performed in a different order than illustrated.

In step 210, the selecting module 110 selects a digital image from the memory 22 of the imaging device. As mentioned above, the digital image has a predefined date stamp location.

In step 220, the image processor 120 obtains and saves the image data, from the digital image, and the position coordinates of the predefined date stamp location from a header of the digital image file.

In step 230, the date generator 130 generates a current date or a selected date for users verification. If the date generator 130 acts as a system clock of the imaging device, the date generator 130 generates a current date for users to verify. If a user want to modify the date of the digital image, then the user can enter a date, and the generator 130 then generates a new date from the user input.

In step 240, if the digital image is without a date stamp, then the modifying module 140 can modify the image data of the predefined date stamp location with the new date to form a first date stamp. If the digital image already has a date stamp, the modifying module 140 can modify the image data of the predefined date stamp location with the new date to form a new date stamp.

In step 250, the editing module 150 can apply the first date stamp according to the position coordinate of the predefined date stamp location if the digital image does not have a date stamp. If the digital image already has a date stamp, the editing module 150 can replace the old date stamp with the new date stamp according to the position coordinate of the predefined date stamp location. For example, the editing module 150 may change pixel values of an old date stamp to be the same as pixel values of the new date stamp according to the position coordinate of the predefined date stamp location.

If a date stamp of a digital image is incorrect, the method and system for editing the date allow the date stamp to be corrected. If the digital image was not previously date stamped, the method and system for editing the date can stamp the digital image with a selected date. The method and system for editing the date is convenient for users.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for editing a date of a digital image having a predefined date stamp location in an imaging device, wherein an image data and a position coordinate of the predefined date stamp location are stored in a digital image file of the digital image, the method comprising:
selecting the digital image having the predefined date stamp location;
obtaining and saving the image data and the position coordinate of the predefined date stamp location from the digital image;
generating a new date according to a user input;
modifying the image data of the predefined date stamp location with the new date to form a first date stamp; and
applying the first date stamp according to the position coordinates of the predefined date stamp location.

2. The method of claim 1, wherein the digital image file is stored in a format selected from the group consisting of Exif file format, Tag Image File Format, and Joint Photographic Experts Group 2000 format.

3. The method of claim 1, wherein the new date is a current date of the imaging device.

4. A system for editing a date stamp of a digital image having a predefined date stamp location in an imaging device, wherein an image data and a position coordinate of the predefined date stamp location are stored in a digital image file of the digital image, the system comprising:
a selecting module for selecting the digital image file having the predefined date stamp location;
an image processor module for obtaining and saving the image data and the position coordinate of the predefined date stamp location from the digital image file;
a date generator for generating a new date according to a user input;
a modifying module for modifying the image data of the predefined date stamp location with the new date to form a first date stamp; and
an editing module for applying the first date stamp according to the position coordinate of the predefined date stamp location.

5. The system of claim 4, wherein the generator is a system clock of the imaging device.
